(19) United States
(12) Patent Application Publication
(10) Pub. No.: US 2002/0060793 A1
(43) Pub. Date: May 23, 2002

(54) Optical positional displacement measuring apparatus and adjustment method thereof

(75) Inventor: Tatsuo Fukui, Kawasaki-shi (JP)

Correspondence Address: OLIFF & BERRIDGE, PLC, P.O. BOX 19928, ALEXANDRIA, VA, 22320, US

(73) Assignee: NIKON CORPORATION, Tokyo (JP)

(21) Appl. No.: 09/990,260

(22) Filed: Nov. 23, 2001

(30) Foreign Application Priority Data
Nov. 22, 2000 (JP) 2000-356350

(51) Int. Cl. G01B 11/00

(52) U.S. Cl. 356/400

(57) ABSTRACT

An optical position displacement measuring device comprises an illumination optical system for illuminating a measurement mark, an image formation optical system for forming an image of the measurement mark by converging light reflected from the measurement mark, a CDD camera for capturing the image of the measurement mark formed by the image formation optical system, an image processing device for measuring positional displacement of the measurement mark from obtained image signals, an auto focus device for carrying out auto focus adjustment, and a controller. In order to carry out adjustment of a measurement error of an optical position displacement measuring device, the controller initially carries out auto focus adjustment, secondly carries out adjustment of an image formation aperture stop of the image formation optical system, thirdly carries out adjustment of a second objective lens of the image formation optical system, and finally carries out adjustment of the illumination aperture stop of the illumination optical system.

### INCORPORATION BY REFERENCE

The disclosure of the following priority application is herein incorporated by reference:

Japanese Patent Application No. 2000-356350 filed Nov. 22, 2000.

### BACKGROUND OF THE INVENTION

1. Field of the Invention

The present invention relates to an optical positional displacement measuring device for optically detecting positional displacement of a resist pattern of a base pattern formed on a substrate, and specifically relates to technology for adjusting the optical displacement measurement device.

2. Description of the Related Art

In a photolithography manufacturing process, which is an example of a semiconductor chip manufacturing process, a resist pattern is formed in a number of stages on a wafer. Specifically, for each stage, specified resist patterns are formed one on top of the other on a pattern (hereafter called a base pattern) formed over the wafer. At this time, with respect to the base pattern, it is not possible to obtain desired performance with positional displacement of the resist patterns formed on top of one another on the base pattern. As a result, there is a demand for accurate positioning when carrying out superpositioning. It is therefore necessary to measure positional displacement with respect to the base pattern when superpositioning resist patterns, for each formation stage of the resist patterns. A device for measuring positional displacement when superimposing layers is disclosed in Japanese Patent Laid-open No. 2000-77295.

In order to measure positional displacement in superpositioning at the time of forming a resist pattern, a resist mark is formed on a base mark formed on a substrate. An optical positioning displacement measuring device (overlay position displacement measuring device) takes an image of a measurement mark through a measurement optical system using a CCD camera or the like, and measures overlay position displacement of a resist mark with respect to the base mark.

When optically measuring overlay position displacement, it is impossible to avoid an optical aberration occurring in the measurement optical system. If there is aberration in a visual field of the measurement optical system, particularly an aberration that is rotationally asymmetrical about an optical axis, a measurement error TIS (Tool Induced Shift) arises in the overlay position displacement measurement values.

By carrying out overlay position displacement measurement still with the measurement error TIS, accurate position displacement measurement is not possible. In the overlay position displacement measurement device described above, before measurement of overlay position displacement, positional adjustment is carried out for an illumination aperture stop, with an image formation aperture stop and an objective lens being used in the measurement optical system, so as to reduce the measurement error TIS.

However, it is difficult to remove the measurement error TIS using any one of the adjustment elements, such as the illumination aperture stop, image formation aperture stop and objective lens etc. It may be necessary to remove the measurement error TIS by adjustment with a suitable combination of a plurality of adjustment elements. However, the plurality of adjustment elements exert influence on each other, causing the measurement error TIS to be subtly changed, which means that there is a problem that it is extremely difficult to appropriately combine adjustment of the plurality of adjustment elements.

Also, it is common to build an auto-focus optical system into the measurement optical system of the overlay position displacement measurement device. At the same time as removing the measurement error TIS, it is also necessary to adjust the auto-focus optical system, and the adjustment operation is extremely complicated.

### SUMMARY OF THE INVENTION

The object of the present invention is to provide an optical position displacement measuring device that can simply carry out an adjustment operation for the optical system of the optical position displacement measurement device, and an adjustment method for such a measuring device.

In order to achieve the above described object, an optical position displacement measuring device, according to the invention, comprises an illumination optical system for illuminating a measurement mark; an image formation optical system for converging light reflected from the measurement mark to form an image of the measurement mark; a image capturing device for capturing an image of the measurement mark that has been formed by the image formation optical system; an image processing device for performing image processing of image signals obtained by the image capturing device to measure positional displacement of the measurement mark; and a controller capable of positional adjustment of a plurality of optical elements constituting the illumination optical system and the image formation optical system, for carrying out positional adjustment of the plurality of optical elements in the predetermined sequence to adjust a measurement error.

### BRIEF DESCRIPTION OF THE DRAWINGS

FIG. 1 is a drawing showing the structure of an optical positional displacement measuring device of the present invention.

FIG. 2A is a drawing showing an image formation state of an auto focus device.

FIG. 2B is a drawing showing an image formation state of an auto focus device.

FIG. 2C is a drawing showing an image formation state of an auto focus device.

FIG. 3A is a plan view of a measurement mark used in optical position displacement detection.

FIG. 3B is a cross sectional view of a measurement mark used in optical position displacement detection.

FIG. 4A is a plan view showing the measurement mark shown in FIG. 3A at a position rotated by 0°.

FIG. 4B is a plan view showing the measurement mark shown in FIG. 3A at a position rotated by 180°.

FIG. 5A is a drawing showing image formation conditions for an AF sensor of the auto focus device.

FIG. 5B is a drawing showing an image signal strength profile of an image formed in the AF sensor.

FIG. 6A is a plan view of an L/S mark.

FIG. 6B is a cross sectional view of an L/S mark.

FIG. 6C is a drawing showing an image signal strength profile for an L/S mark image.

FIG. 7 is a drawing showing a QZ curve for the whole of an L/S mark.

FIG. 8A is a drawing showing the characteristics of a QZ curve changing with adjustment of a illumination aperture stop.

FIG. 8B is a drawing showing characteristics of a QZ curve changing with adjustment of an image forming aperture stop.

FIG. 8C is a drawing showing characteristics of a QZ curve changing with adjustment of a second objective lens.

FIG. 9 is a drawing showing change of a QZ curve in the case of sequentially carrying out image formation aperture stop adjustment, second objective lens adjustment and illumination aperture stop adjustment.

FIG. 10 is a flow chart showing a sequence for automatically carrying out auto focus adjustment, image formation aperture stop adjustment, second objective lens adjustment and illumination aperture stop adjustment.

FIG. 11 is a flow chart showing a sequence for automatically carrying out auto focus adjustment, image formation aperture stop adjustment, second objective lens adjustment and illumination aperture stop adjustment.

### DESCRIPTION OF THE PREFERRED EMBODIMENTS

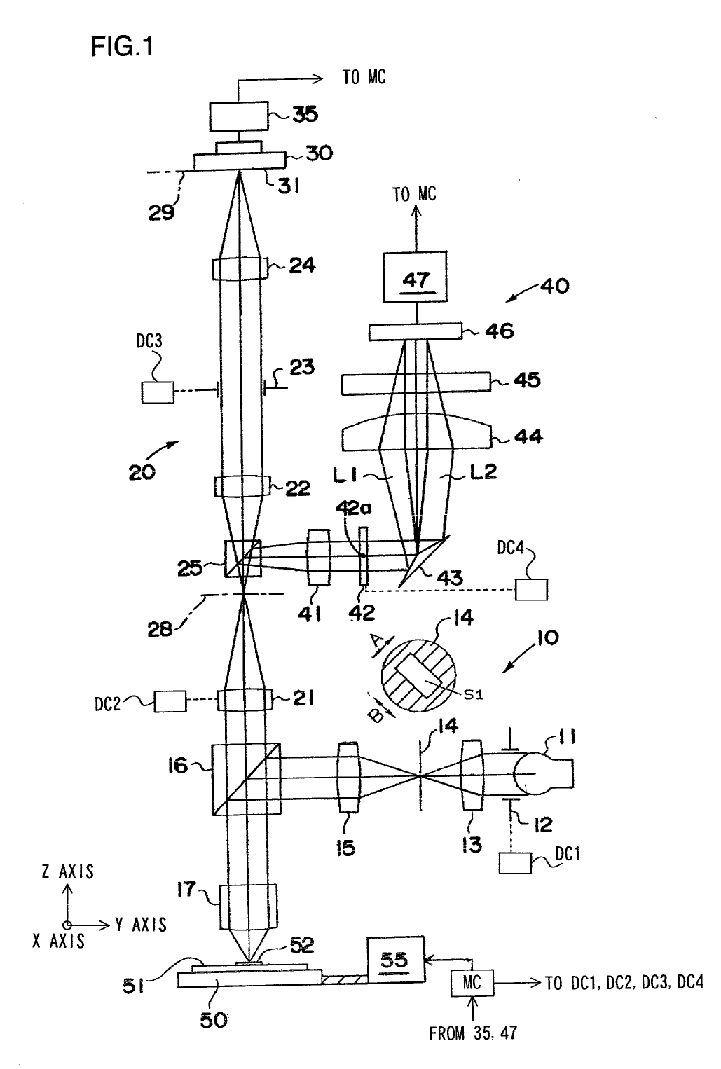

Referring to the drawings, an optical position displacement measurement device of the present invention, and an adjustment method therefore, will be described. FIG. 1 is a drawing showing the structure of an optical position displacement measuring device of a first embodiment of the present invention. In FIG. 1, a direction perpendicular to the page of FIG. 1 is made the X axis direction, a direction extending in the lateral direction of FIG. 1 is made the Y axis, and a direction extending vertically in FIG. 1 is made the Z axis.

The optical position displacement measuring device shown in FIG. 1 measures overlay positional displacement of a resist mark on a measurement mark 52 formed on a wafer 51. In order to accurately measure overlay position displacement, it is necessary to remove a measurement error of the optical position displacement measuring device. The optical position displacement measuring device of the present invention is capable of simply carrying out an adjustment operation in order to remove a measurement error.

At the time of position displacement measurement, the wafer 51 is mounted on a stage 50. The stage 50 is constructed so as to be capable of rotational and horizontal movement (movement in the X-Y direction) and capable of up and down movement (movement in the Z direction). Movement of the stage 50 is controlled by a stage controller 55.

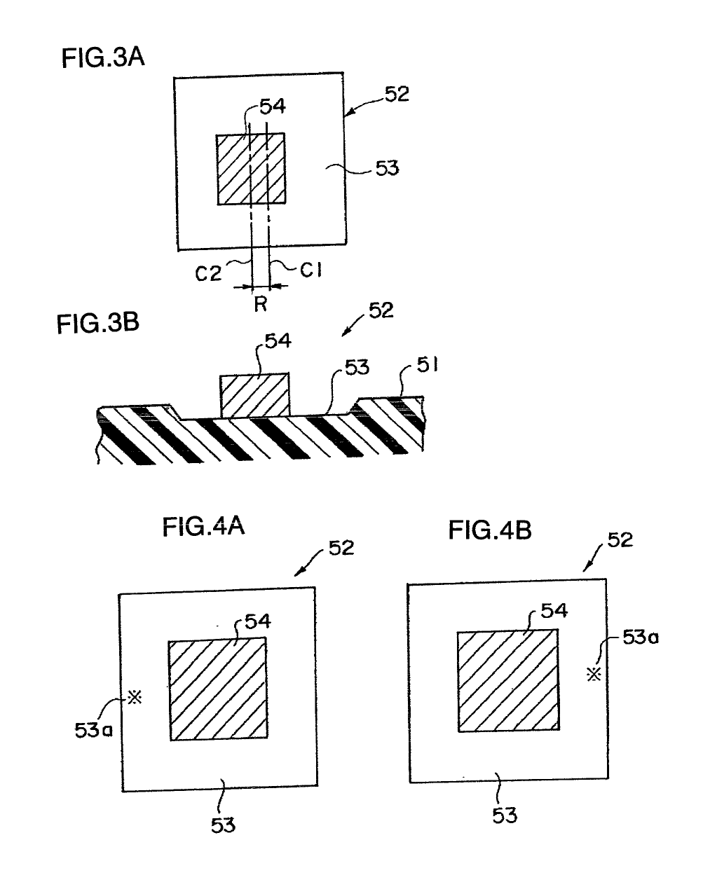

A measurement mark 52 on the wafer 51 is formed when forming specified resist patterns on a base pattern on the wafer 51 using a photolithographic process. One example of the measurement mark 52 is shown in FIG. 3A and FIG. 3B. As shown in FIG. 3A and FIG. 3B, the measurement mark 52 is made up of a rectangular base mark 53 formed on an end section of the wafer 51 and a resist mark 54 formed on the base mark 53. The optical position displacement measuring device of the present invention measures overlay positional displacement of the resist mark 54 with respect to the base mark 53. Position displacement measurement will be described later.

First of all, the structure of the optical position displacement measuring device will be described.

As shown in FIG. 1, the optical position displacement measuring device comprises an illumination optical system 10 for irradiating light to the measurement mark 52, an image formation optical system 20 for allowing formation of an image of the measurement mark 52 by condensing reflected light from the measurement mark 52, a image capturing device 30 for capturing the formed image of the measurement mark 52, an image processing section 35 for processing image signals obtained by the image capturing device 30, and an auto focusing device 40 for carrying out focus control in order to capture the image using the image capturing device 30.

The illumination optical system 10 is provided with a light source 11, an illumination aperture stop 12 and a condensing lens 13. Illumination luminous flux from the light source 11 is constricted into a beam with a specific diameter by the illumination aperture stop 12, then input to the condensing lens 13 so as to be condensed. Illumination light condensed by the condensing lens 13 is uniformly irradiated on a field stop 14.

As shown by the hatching in FIG. 1, the field stop 14 has a rectangular aperture S1. With the field stop 14 shown by the hatching, an up down direction in FIG. 1 is a Z axis direction, and a lateral direction in FIG. 1 is the X axis direction. That is, an aperture S1 of the field stop 14 is provided inclined at 45 degrees with respect to the X axis and the Z axis respectively. The aperture S1 is shown enlarged in order to make it easier to see. A drive system DC1 for performing positional adjustment (position in the X-Z direction) of the illumination aperture stop 12 is provided in the illumination optical system 10 in order to adjust the measurement error which will be described later.

Illuminating light that passes through the aperture S1 of the field stop 14 and is emitted is incident on an illumination relay lens 15. The illuminating light is collimated by the illumination relay lens 15 to give a parallel light flux. The illuminating light is incident on a first beam splitter 16 as a parallel light flux. Illuminating light reflected in the first beam splitter 16 comes out in a downward direction in FIG. 1, and is converged by a first objective lens 17. Illuminating light converged by the first objective lens 17 perpendicularly irradiates the measurement mark 52 on the wafer 51. Here, the field stop 14 and the measurement mark 52 are arranged at conjugate positions in the illumination optical system 10. With respect to the measurement mark 52 of the wafer 51, a rectangular region corresponding to the shape of the aperture S1 is irradiated by illuminating light.

A surface of the wafer 51 including the measurement mark 52 is irradiated by illuminating light as described above. Next, reflected light of the wafer 51 including the measurement mark 52 will be described.

Reflected light of the illuminating light that has irradiated the surface of the wafer 51 including the measurement mark 52 is guided through the image formation optical system 20 to the image capturing device 30. Reflected light is collimated by the first objective lens 17 to become a parallel light flux. Reflected light that has been turned into a parallel light flux penetrates the first beam splitter 16, and an image of the measurement mark 52 is formed on a primary image formation surface 28 by a second objective lens 21 arranged above the first beam splitter 16. Also, reflected light penetrates a second beam splitter 25 and a first image formation relay lens 22, is constricted into a beam of a specific diameter by an image formation aperture stop 23, and an image of the measurement mark 52 is formed on a secondary image formation surface 29 by a second image formation relay lens 24. Drive systems DC2 and DC3 for performing positional adjustment (position in the X-Y direction) of the second objective lens 21 and the image formation aperture stop 23 are provided in the image formation optical system 20 in order to adjust the measurement error which will be described later.

The drive system DC1 for performing positional adjustment of the illumination aperture stop 12, the drive system DC2 for performing positional adjustment of the second objective lens 21, and the drive system DC3 for performing positional adjustment of the image formation aperture stop 23 are respectively drive controlled by a main controller MC.

The image capturing device 30 is comprised of a CCD camera etc. An image surface 31 of the CCD camera 30 and the secondary image formation surface 29 of the above described image formation optical system 20 are arranged so as to be matched. An image of the measurement mark 52 is captured by the CCD camera 30. Image signals obtained by the CCD camera 30 are sent to the image processing device 35, and subjected to signal processing as described later. As will be understood from this arrangement, the measurement mark 52 and the image surface 31 have a conjugate positional relationship.

Next, the auto focusing device 40 will be described.

The second beam splitter 25 is provided to the rear of the primary image formation surface 28 of the image formation optical system 20, specifically, above the primary image formation surface 28. The auto focusing device 40 is provided at a position where reflected light branched by the second beam splitter 25 is received. In the auto focusing device 40 light flux branched from the second beam splitter 25 is incident of an AF first relay lens 41 and collimated into a parallel light flux. The reflected light that has been made into a parallel light flux passes through a plane parallel glass plate 42, and an image of the illumination aperture stop 12 is formed in a pupil split mirror 43.

The plane parallel glass plate 42 is constructed so as to be tilt adjustable by the drive system DC4 centering on an axis 42a that is parallel to the X axis, and adjustment is performed to allow parallel movement of the parallel light flux in the Z direction using photorefraction. In this way, as will be described later, positional adjustment for setting the center of an image of the illumination aperture stop 12 to the center of the pupil split mirror 43 is possible.

In FIG. 1, the optical axis of light branched from the second beam splitter 25 is shown parallel to the optical axis of the illumination optical system 10. However, in actual fact, the second beam splitter 25 is arranged so that the optical axis of branched light becomes a direction inclined at 45 degrees on the X-Y plane with respect to the illumination optical system 10. Specifically, when looking at FIG. 1 from the Z axis direction, the optical axis of the illumination optical system 10 and the optical axis of the branched light are at an angle of 45 degrees. A direction of slit S1 shown by the arrow A (called a measurement direction) is an up down direction of the sheet of FIG. 1, namely, the Z axis direction, in a path leading from the second beam splitter 25 to the pupil split mirror 43. Also, a direction of slit S1 shown by the arrow B (called a non-measurement direction) is a direction perpendicular to the sheet of FIG. 1, namely, the X axis direction, in a path leading from the second beam splitter 25 to the pupil split mirror 43. In the path leading from the pupil split mirror 43 to an AF sensor 46 that will be described later, the measurement direction shown by arrow A becomes the Y axis direction, and the non-measurement direction shown by arrow B becomes the X axis direction.

As described above, the parallel light flux incident on the pupil split mirror 43 is divided into two in the measurement direction, namely the Y-axis direction, to give two light fluxes L1 and L2 incident on a AF second relay lens 44. The light fluxes L1 and L2 condensed by the AF second relay lens 44 are converged in the non-measurement direction, that is the X axis direction, by a cylindrical lens 45 having a convex lens shape in a cross section parallel to the X-Y plane. The cylindrical lens 45 does not have refractive power in the Y axis direction of FIG. 1, namely the measurement direction. The two light fluxes L1 and L2 are condensed in the measurement direction by the AF second relay lens 44 and converged in the non-measurement direction by the cylindrical lens 45, to form respective light source images on an AF sensor 46 made of a line sensor.

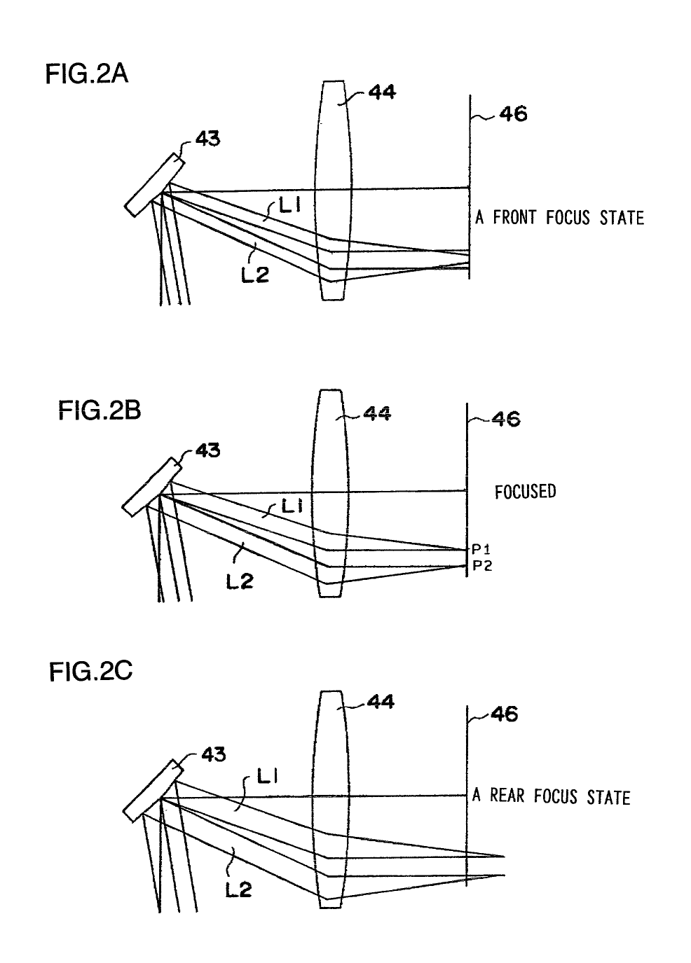

As has been described above, two light source images are formed on the AF sensor 46 of the auto focusing device 40. States of forming the light source images are shown in FIG. 2A-FIG. 2C. FIG. 2A shows a state where the image formation position is in front of the AF sensor 46. FIG. 2B shows the state where images are focused on the AF sensor. FIG. 2C shows a state where the image formation position is behind the AF sensor 46. Previous positional setting is carried out so that an image of the wafer 51 is focused on the CCD camera in the state with two light source images focused as shown in FIG. 2B. If the image formation position deviates from the focus position, a distance between central positions P1 and P2 of the two light source images on the AF sensor 46 becomes narrower or wider. That is, by detecting the distance between central positions P1 and P2 of the two light source images formed on the AF sensor 46, it is possible to determine whether or not the images formed by the CCD camera 30 are focused.

For example, if the stage 50 on which the wafer 51 is mounted is moved downwards from a state where the image of the wafer 51 is focused on the CCD camera 30, the image formation position will be in front of the AF sensor 46, as shown in FIG. 2A. At this time, the central positions of the two light source images are closer together. On the other hand, if the stage 50 on which the wafer 51 is mounted is moved upwards from a state where the image of the wafer 51 is focused on the CCD camera 30, the image formation position will be behind the AF sensor 46, as shown in FIG. 2C. At this time, the central positions of the two light source images are further apart.

Detection signals from the AF sensor 46 are sent to the AF signal processing section 47. The AF signal processing section 47 calculates a distance between the central positions of the two light source images formed on the AF sensor 46. Further, the AF signal processing section 47 compares the calculated distance between central positions with a central position distance for the focused state previously measured and stored, and calculates a difference between the two distances. The calculated distance difference is output to the main controller MC as focal point position information. The main controller MC controls movement of the stage controller 55 based on the input focal point position information so that the image of the wafer 51 is focused in the CCD camera 30.

A distance between central positions of two light source images on the AF sensor 46 for the state where the image of the wafer 51 is focused on the CCD camera 30 is previously measured and stored in the AF signal processing section 47. A difference between the previously stored distance between central positions and an actually detected distance between central positions is a difference from the focused state, and this difference is output to the main controller MC as focal point position information. The main controller MC controls movement of the stage controller 55 to move the stage 50 and the wafer 51 up and down so that the difference in the central position distance from the focused state disappears. Adjustment to cause focus of the image of the wafer 51 on the CCD camera 30, that is the auto focus adjustment, is carried out by adjusting the distance between central positions of the two light source images as described above.

The two light source images used in the auto focus adjustment are formed from the light flux from a slit S1 elongated in the non-measurement direction (direction of arrow B) formed on the field stop 14 as shown in FIG. 1. The light fluxes L1 and L2 spreading out in the non-measurement direction are converged by the cylindrical lens 45 and focused on the AF sensor 46. In this way, it is possible to average out unevenness in reflection from the surface of the wafer 51, which improves detection precision with the AF sensor 46.

The structure of the optical position displacement measuring device of the present invention has been described above. Next, position displacement measurement using the optical position displacement measuring device will be described.

The measurement mark 52 of the above described wafer 51 is provided for position displacement measurement. As shown in FIG. 3A and FIG. 3B, the measurement mark 52 is made up of a base mark 53, formed from a rectangular indent formed in the surface of the wafer 51, and a resist mark 54 formed on the base mark 53 at the same time as resist pattern formation in a photolithographic manufacturing process. In the photolithographic manufacturing process, the resist mark 54 is set so as to be formed in the middle of the base mark 53. Specifically, an amount of positional displacement of the resist mark 54 with respect to the base mark 53 is the same as the amount of overlay position displacement of the resist pattern with respect to the base pattern.

As shown in FIG. 3A, a distance R between a center line C1 of the base mark 53 and a center line C2 of the resist mark 54 is made an amount of overlay position displacement. The optical position displacement measuring device of the present invention measures the distance R as an amount of overlay position displacement. The amount of overlay position displacement R shown in FIG. 3 is the amount of position displacement in the Y axis direction (sideways direction) shown in FIG. 1. The amount of position displacement in the X axis direction (vertical direction) orthogonal to the Y axis direction is similarly measured.

When carrying out measurement of the amount of overlay displacement R using the measurement mark 52, if there is an aberration in the measurement optical system (the illumination optical system 10 and the image formation optical system 20), particularly a rotationally asymmetrical aberration, there is a problem that measurement error TIS (Tool Induced Shift) is contained in the measurement value of the overlay position displacement R. A simple description will now be given of measurement error TIS. Measurement of the measurement error TIS is carried out with the measurement mark 52 arranged at a 0 degree position and at a 180 degree position, as shown in FIG. 4A and FIG. 4B.

First of all, as shown in FIG. 4A, with a position mark 53a virtually shown in the measurement mark 52 positioned to the left, an amount of overlay position displacement RO of the resist mark 54 with respect to the base mark 53 is measured. Next, as shown in FIG. 4B, the measurement mark 52 is rotated 180 degrees, and an amount of overlay position displacement R180 is measured with the virtual position mark 53a positioned to the right. Measurement error TIS is calculated using equation 1.

TIS=(R0+R180)/2 (equation 1)

Even if the measurement mark 52 is rotated 180 degrees, there is no variation in the extent of the amount of overlay position displacement R. With 180 degrees rotation, the sign of the overlay position displacement R is reversed. The (R0+R180) part of equation 1 then becomes zero. That is, even if there is overlay position displacement of the resist mark 54 with respect to the base mark 53, the measurement error TIS calculated in equation 1 theoretically becomes zero.

However, if there is an optical aberration in the measurement optical system, particularly a rotationally asymmetrical aberration, the aberration is not rotated, even if the measurement mark 52 is rotated 180 degrees as described above. That is, the measurement error TIS calculated using equation 1 represents a value corresponding only to the influence of the aberration.

By measuring the overlay position displacement amount R using the above described optical position displacement measuring device with the measurement error TIS generated by such an optical aberration still included, it is not possible to measure the overlay position displacement amount R accurately. In the optical position displacement measuring device of the present invention, there is adjustment to suppress the above described measurement error TIS as much as possible. Adjustment of the optical position displacement measuring device will be described in the following. A description will also be given of central alignment of the auto focusing device 40 with respect to the pupil split mirror 43.

In order to measure the overlay position displacement amount R, auto focus adjustment is carried out for the image of the wafer 51 captured with the CCD camera 30. In order to accurately carry out auto focus adjustment, adjustment is carried out for the auto focusing device 40.

Reflected light guided to the auto focusing device 40 by the second beam splitter 25 is divided into two light fluxes L1 and L2 by the pupil split mirror 43. At this time, if the light intensity of the two light fluxes L1 and L2 is not equal, auto focus adjustment of the CCD camera 30 will become inaccurate. It is therefore necessary for the light intensity of both light fluxes L1, L2 to be equal. Specifically, it is necessary to match up the center of an image of the illumination aperture stop 12 formed on the pupil split mirror 43 with the center of the pupil split mirror 43.

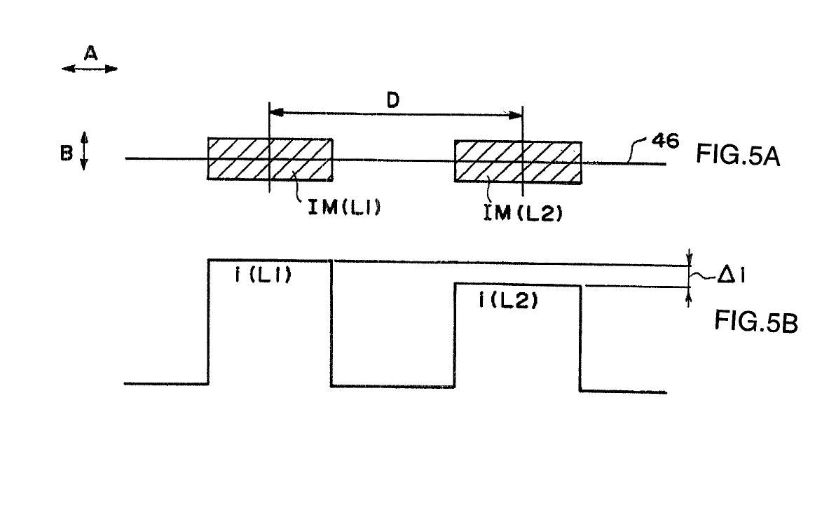

The state where the image of the slit S1 of the field stop 14 is formed on the AF sensor 46 is shown in FIG. 5A. As shown in FIG. 5A, two images IM(L1) and IM(L2) are formed on the AF sensor 46. As described above, the arrow A in FIG. 5A shows a measurement direction, and the arrow B shows a non-measurement direction. The AF sensor 46 detects these two images IM(L1) and IM(L2), and outputs the profile signal as shown in FIG. 5B. If there is a deviation in the division by the pupil split mirror 43 and the light intensities of the two light fluxes L1 and L2 are different, then a difference Δi between the profile signal strengths i(L1) and i(L2) arises, as shown in FIG. 5B. Measurement of the distance D between the central positions of the two images IM(L1) and IM(L2) with the difference Δi still produced is inaccurate. For this reason, when the signal strength difference Δi has been detected, adjustment is carried out to get rid of the difference Δi.

In order to remove the signal strength difference Δi, the light intensities of the light fluxes L1 and L2 are made equal. Tilt adjustment of the plane parallel glass plate 42 is then carried out, and a central optical axis position of the light flux incident on the pupil split mirror 43 is translated to the up and down direction (Z direction). Adjustment is performed so that the central optical axis position of the light flux incident on the pupil split mirror 43 is aligned with the center of the pupil split mirror 43. Setting is done so that the light fluxes L1 and L2 become equal and the signal strength difference Δi becomes zero, and adjustment of the auto focusing device 40 is completed.

With this adjustment, auto focus adjustment using the auto focusing device 40 is carried out accurately.

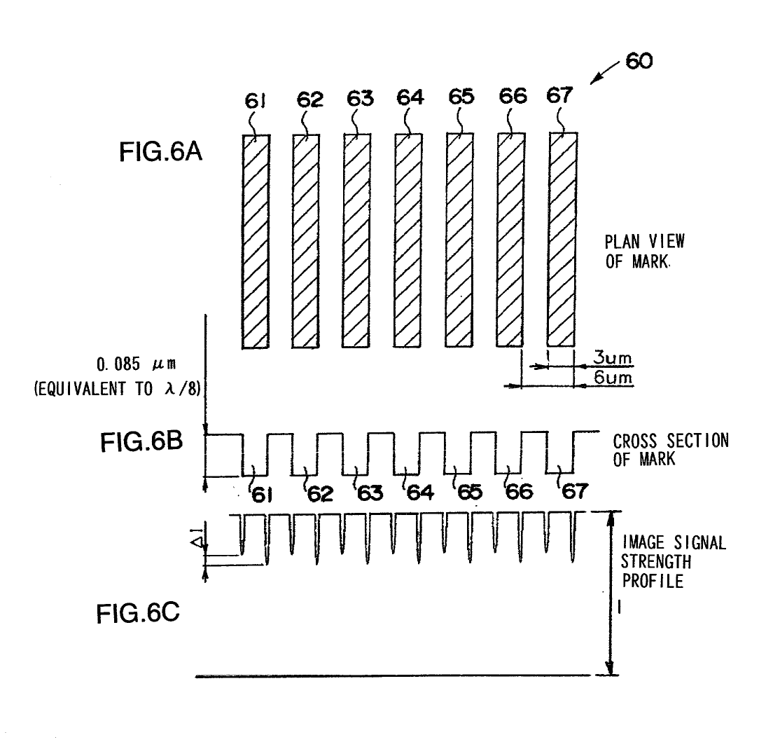

Next, adjustment is performed for the influence of the measurement error TIS. In order to lower the influence of the measurement error TIS, positional adjustment of the illumination aperture stop 12, image formation aperture stop 23 and second objective lens 21 is performed. A wafer having an L/S (line and space) mark with the shape shown in FIG. 6A and FIG. 6B is used to carry out these adjustments. The wafer having the L/S mark 60 is mounted on the stage 50 instead of the wafer 51 shown in FIG. 1. The L/S mark 60 is illuminated using the illumination optical system 10, and an image of the L/S mark 60 is formed by the CCD camera 30. The formed image of the L/S mark is then subjected to image processing by the image processing device 35.

The L/S mark 60 is comprised of a plurality of parallel linear marks 61-67 having a line width of 3 μm and a height in cross section of 0.085 μm (equivalent to ⅛ for the irradiation light λ) on pitches of 0.6 μm, as shown in FIG. 6A and FIG. 6B.

A profile of image signal strength I calculated by subjecting the image of the L/S mark obtained by the CCD camera 30 to image processing in the image processing device 35 is shown in FIG. 6C. As shown in FIG. 6C, signal strength I is lowered at edge or stage positions of each of the linear marks 61-67. A signal strength difference ΔI between the left edge position and the right edge position is calculated for each linear mark 61-67. A signal strength difference ΔI in FIG. 6C represents a signal strength difference at both left and right stage positions of the linear mark 61. The signal strength differences AI for the total of seven linear marks 61-67 are averaged, and asymmetry of the image of the L/S marks is calculated in the image processing device 35. Asymmetry of the image of the L/S marks is represented as a Q value calculated using equation 2 below.

Q=1/7×Σ(ΔI/1)×100(%) (Equation 2)

Here, I is signal strength of each linear mark 61-67.

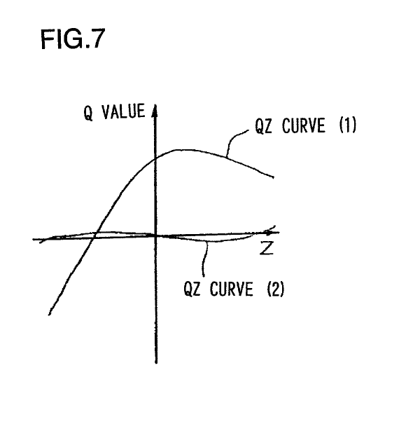

Next, the stage 50 is made to move in the up and down direction in FIG. 1 (Z direction), to thus move the L/S mark 60 in the Z direction. A Q value is calculated for each height position (each position in the Z direction) and by obtaining a focus characteristic for the Q values a characteristic curve, hereinafter referred to as a QZ curve, as shown for example in FIG. 7 is obtained.

In FIG. 7, there are two types of QZ curve, namely QZ curve (1) and QZ curve (2). As shown in FIG. 7, QZ curve (1) represents the case where the Q values representing the asymmetry of the image of the L/S marks change significantly with Z direction position, meaning that a rotationally asymmetrical aberration is large. On the other hand, the QZ curve (2) represents the case where the change in Q values is small, meaning that the rotationally asymmetrical aberration is small. For this reason, it can be considered that it is better to adjust the position of the illumination aperture stop 12, image formation aperture stop 23 and second objective lens 21 of the optical position displacement measuring device, and adjust the calculated QZ curve so that the change in Q values becomes small, as in QZ curve (2).

A brief description will now be given of adjustment to make changes of the QZ curve small and reduce the rotationally asymmetric aberration, called QZ adjustment.

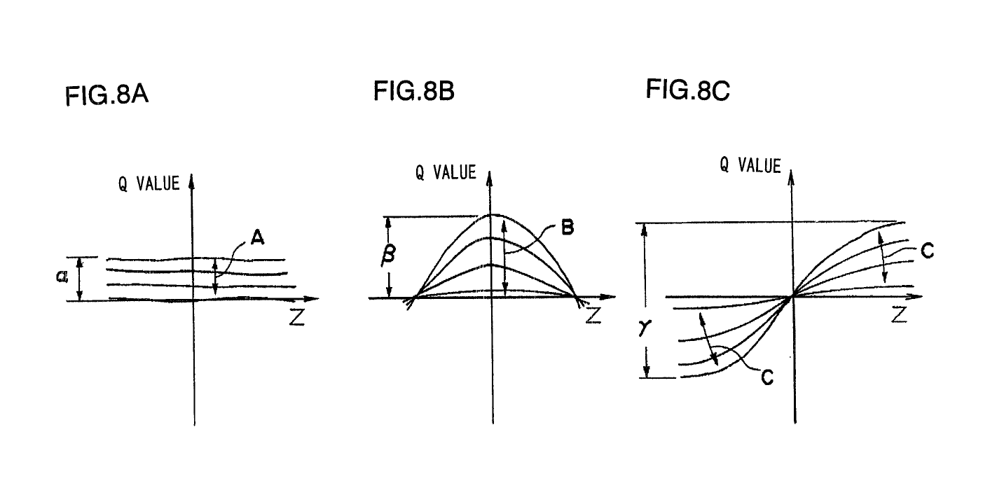

QZ adjustment is carried out by adjusting the positions of the illumination aperture stop 12, image formation aperture stop 23 and second objective lens 21, as described above. The way in which the QZ curve changes varies depending on the respective positional adjustments. FIG. 8A-FIG. 8C is show the characteristics of change in QZ curve changing for each positional adjustment.

If positional adjustment of the illumination aperture stop 12 is carried out, it results in adjustment to cause an upward or downward parallel shift of the QZ curve, as shown by the arrow A in FIG. 8A. As shown in FIG. 8A, the maximum Q value of each QZ curve, that is, an amount of shift necessary to cause parallel movement of the QZ curve to the Z axis, is termed shift amount α. If positional adjustment of the image formation aperture stop 23 is carried out, it results in adjustment to even out the convex shape of the QZ curve, as shown by arrow B in FIG. 8B. As shown in FIG. 8B, a maximum projection amount of each QZ curve is termed projection amount β. If positional adjustment of the second objective lens 21 is carried out, it results in adjustment to cause variation in the inclination angle of the QZ curve, as shown by the arrow C in FIG. 8C. As shown in FIG. 8C, a difference between the maximum value and minimum value for each QZ curve is termed inclination amount γ.

With the present invention, the simplest and most suitable adjustment method is adopted, taking into consideration change characteristics of the QZ curve due to the respective adjustments.

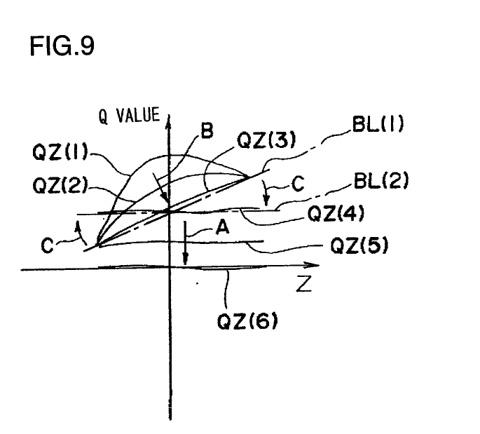

Generally, in a state where an optical position displacement measuring device having the structure shown in FIG. 1 is mechanically assembled only to meet design values, the QZ curve is out of alignment by quite a significant amount. The QZ curve at this time exhibits a characteristic like QZ (1) in FIG. 9. The disordered QZ curve like that shown by QZ(1) is subjected to adjustment using the following procedure in order to put it in the state shown by QZ curve (2) in FIG. 7.

First of all, the image formation aperture stop 23 having very sensitive adjustment sensitivity is adjusted. The position of the image formation aperture stop 23 in the X-Y direction is adjusted using the drive system DC3, and the convex shape of the QZ curve is made even as shown in FIG. 8B. Specifically, as shown by the arrow B in FIG. 9, adjustment is carried out to level the curve QZ(1) from curve QZ(2) to curve QZ (3). A straight line linking both ends of each QZ curve is a first reference line BL(1). This adjustment is carried out so that the projection amount β of the curve QZ(3) with respect to the first reference line BL(1) becomes within a specified range, for example, within ±0.5%. The projection amount β of the curve QZ(1) before adjustment is made 100% with respect to the first reference line BL(1).

Next, positional adjustment of the second objective lens 21 is carried out. The position of the second objective lens 21 in the X-Y direction is adjusted using the drive system DC2, to cause variation in the inclination of the QZ curve as shown in FIG. 8C. Specifically, as shown by the arrow C in FIG. 9, adjustment is carried out to change the inclination of the curve QZ (3) that has been made flat by the positional adjustment of the image formation aperture stop 23 to become horizontal and parallel to the Z axis, as shown by curve QZ(4). Since the QZ curve is leveled out (linearized) by positional adjustment of the image formation aperture stop 23 before inclination adjustment, it is possible to carry out inclination adjustment of the QZ curve accurately. A horizontal line passing through central positions of the curve QZ(3) and the curve QZ(4) is made a second reference line BL(2). This adjustment is carried out so that an amount of inclination γ of the curve QZ (4) with respect to the second reference line BL(2) is within a specified range, for example, within ±1.0%. The amount of inclination γ of the curve QZ(3) before adjustment is 100% with respect to the second reference line BL(2).

With the positional adjustment of the image formation aperture stop 23 and the second objective lens 21, the QZ curve becomes close to a straight line parallel with the Z axis, as shown by the curve QZ (4). A distance between the curve QZ (4) and the Z axis represents an amount of positional displacement of the illumination aperture stop 12. Adjustment of the position of the illumination aperture stop 12 in the X-Z direction is then carried out using the drive system DC1. As shown by the arrow A in FIG. 9, the curve QZ(4) that is substantially a horizontal straight line is subjected to horizontal shift from Curve QZ(5) to curve QZ(6). This adjustment is carried out so that the amount of shift α of the curve QZ(6) is within a specified range, for example, within ±0.5%. The amount of shift α of the curve QZ(4) before adjustment is 100% with respect to the Z axis.

As a result of the positional adjustment described above, the rotationally asymmetric aberration of the measurement optical system becomes small, as shown by curve QZ(6). In this way, it is possible to reduce measurement error TIS when measuring an amount of overlay positional displacement using the optical position displacement measuring device.

The adjustment sensitivity of the illumination aperture stop 12 is lower than the adjustment sensitivity of the image formation aperture stop 23 and the second objective lens 21, and even if there is some positional displacement of the illumination aperture stop 12, the amount of variation in parallel shift amount a constituting a determination index for the adjustment sensitivity of the illumination aperture stop 12 is small. For this reason, adjustment of the illumination aperture stop 12 is carried out after adjustment of the image formation aperture stop 23 and the second objective lens 21, and accurate determination of the amount of adjustment of the illumination aperture stop 12 is made.

Adjustment of the auto focus device 40 is carried out before adjusting the image formation aperture stop 23, second objective lens 21 and illumination aperture stop 12. However, since the illumination optical system 10 also serves as an optical path for the auto focusing device 40, adjustment of the auto focusing device 40 is affected by adjustment of the illumination aperture stop 12. After the above described adjustments, tilt adjustment of the plane parallel glass plate 42 of the auto focusing device 40 is repeated so that an image to be captured by the CCD camera 30 is focused. After adjustment of the auto focusing device 40, the auto focusing device 40 automatically performs auto focus adjustment for the CCD camera 30.

The above described adjustment of the auto focusing device 40 and QZ adjustment are carried out in the following procedure.

(1) Tilt adjustment of the plane parallel glass plate 42 in the auto focusing device 40.

(2) Adjustment of the image formation aperture stop 23.

(3) Adjustment of the second objective lens 21.

(4) Adjustment of the illumination aperture stop 12.

(5) Readjustment of the plane parallel glass plate 42.

Adjustment in steps (1)-(4) is carried out, and if the Q value shown by the QZ curve is not within a predefined standard, adjustment in steps (1)-(4) is repeated until the Q value is within the standard. Once the Q value enters the standard range, adjustment in step (5) is carried out, and adjustments are completed.

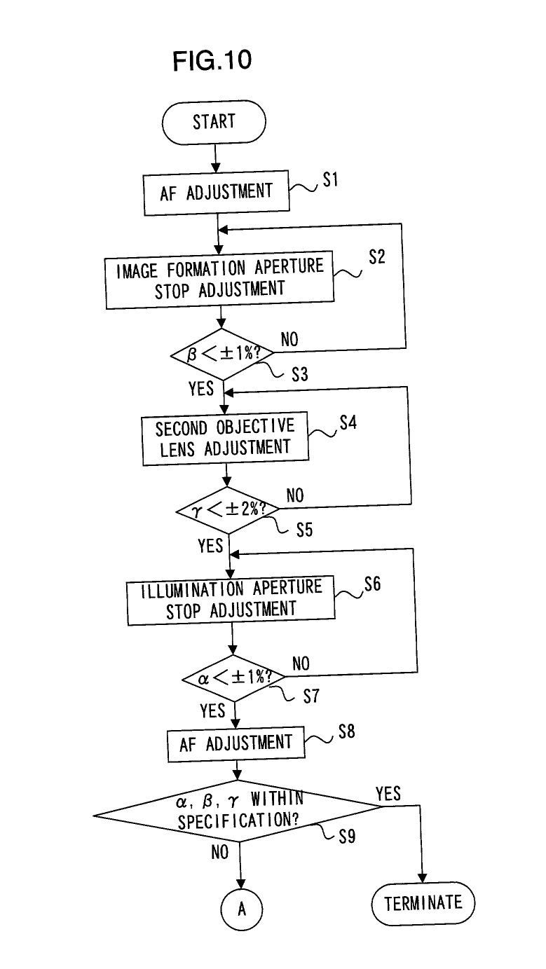

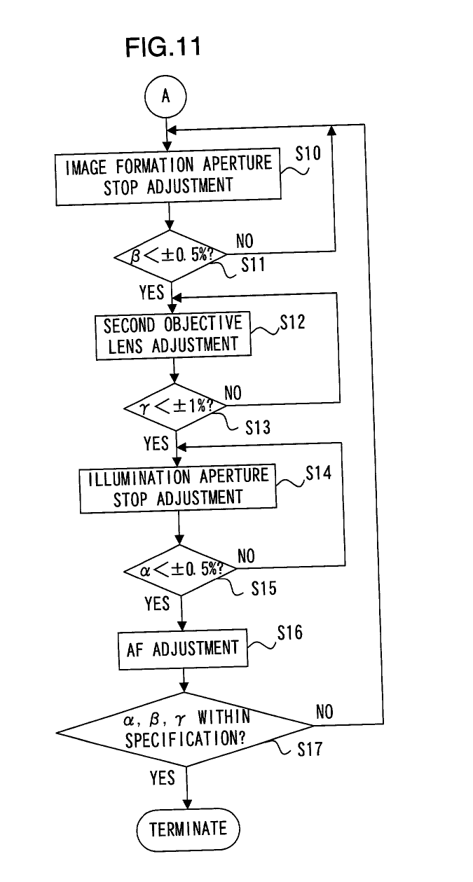

In the optical position displacement measuring device and adjustment method of the present invention, it is possible to automate the above described adjustments. The Flowcharts of FIG. 10 and FIG. 11 show a sequence for automatically carrying out auto focus adjustment, image formation aperture stop adjustment, second objective lens adjustment and illumination aperture stop adjustment. These adjustment processes are controlled by the main controller MC. Description will now be given with reference to the flowcharts of FIG. 10 and FIG. 11, and FIG. 9.

In step 1, adjustment is carried out for the plane parallel glass plate 42 of the auto focusing device 40, and auto focus adjustment is carried out. However, auto focus adjustment is normally carried out automatically.

Adjustment of the image formation aperture stop 23 is carried out in step S2. As shown by the arrow B in FIG. 9, this adjustment flattens the curve QZ(1) from curve QZ(2) to curve QZ(3) to approach the ideal QZ curve. In step S3, it is determined whether or not the amount of projection β of the curve QZ(3) with respect to the first reference line BL(1) is within ±1%. If it is determined in step S3 that the amount of projection β of the curve QZ(3) is within ±1%, processing proceeds to step S4.

In step S4 positional adjustment of the second objective lens 21 is carried out. With this adjustment, as shown by the arrow C in FIG. 9, the inclination of the leveled curve QZ(3) is moved to the horizontal as shown by the curve QZ(4). In step S5, it is determined whether or not an amount of inclination γ of the curve QZ (4) with respect to the second reference line BL(2) is within ±2%. If it is determined in step S5 that the amount of inclination γ of the curve QZ(4) is within ±2%, processing proceeds to step S6.

In step S6, positional adjustment of the illumination aperture stop 12 is carried out. As shown by the arrow A in FIG. 9, this adjustment subjects the curve QZ(4) that is a horizontal straight line to horizontal shift from Curve QZ(5) to curve QZ(6) to approach the ideal QZ curve. In step S7, it is determined whether or not an amount of shift a of the curve QZ(6) with respect to the Z axis is within ± 1%. If it is determined in step S7 that the amount of shift α of the curve QZ(6) is within ±1%, processing proceeds to step S8.

Primary adjustment is completed using the above described steps S1-S7. However, there is a possibility that there will be variations in auto focus adjustment using adjustment of the illumination aperture stop 12. In step S8, adjustment of the plane parallel glass plate 42 is carried out and the auto focus adjustment is carried out again. In step S9, it is determined whether or not the amount of projection β, the amount of inclination γ, and the amount of shift α are within specified ranges. For example, it is determined whether or not the amount of projection β is within ±0.5%, and the amount of inclination γ is within ±1%, and the amount of shift α is within ±0.5%. If there is a positive determination in step S9, the adjustment is not necessary any more and so automatic adjustment is terminated.

On the other hand, if there is a negative determination in step S9, processing advances to step S10 to carry out secondary adjustment if the amount of projection β, the amount of inclination γ, and the amount of shift α are not within specified ranges. In step S10 positional adjustment of the image formation aperture stop 23 is carried out, and in step S11 it is determined whether or not the amount of projection β of the QZ curve is within ±0.5%. If there is a positive determination in step S11, processing advances to step S12 and positional adjustment of the second objective lens 21 is carried out. In step S13 it is determined whether or not the amount of inclination γ of the QZ curve is within ±1%. If there is positive determination in step S13, processing advances to step S14 and positional adjustment of the illumination aperture stop 12 is carried out. In step S15 it is determined whether or not the amount of shift α of the QZ curve is within ±0.5%.

If there is positive determination in step S15, the plane parallel glass plate 42 is adjusted, and auto focus adjustment is carried out again in step S16. In step 17, it is determined whether or not the amount of projection β is within ±0.5%, the amount of inclination γ is within ±1%, and the shift amount α is within ±0.5%, that is, it is determined whether or not amount of projection β, amount of inclination γ and shift amount α are within specified ranges. If there is a negative determination in step S17 that the amount of projection β, the amount of inclination γ, and the amount of shift α are not within specified ranges, processing returns to step S10 and secondary adjustment is carried out again. On the other hand, if there is a positive determination in step S17 that the amount of projection β, the amount of inclination γ, and the amount of shift α are within specified ranges, automatic adjustment is terminated.

As has been described above, a plurality of optical elements constituting an illumination optical system and an image formation optical system, for example, an illumination aperture stop, an image formation aperture stop, and a second objective lens, are adjusted in a specified procedure, which means that it is possible to simply and reliably perform adjustment of measurement error TIS. Line and space mark (L/S mark) is used when performing positional adjustment of the plurality of optical elements. In this way, it is possible to reliably eliminate measurement error TIS in the event that the illumination optical system or the image formation optical system has an aberration, particularly a rotationally asymmetric aberration. Also, image signals of the L/S mark taken by a image capturing device are subjected to image processing, and a value representing the asymmetry of the L/S mark is calculated. This value is calculated by moving the L/S mark in the direction of the optical axis, and a characteristic curve showing a relationship between the asymmetry of the L/S mark and the position in the direction of the optical axis is calculated. Positional adjustment of the plurality of optical elements can be carried out easily and reliably based on this characteristic curve.

According to the present invention, since adjustment of a plurality of optical elements is carried out in a specified order, these adjustments can be easily automated. By automating the adjustments, it is possible to more easily and reliably eliminate measurement error TIS. It is also possible to perform adjustment of an auto focus optical system together with positional adjustment of the optical elements constituting the illumination optical system and the image formation optical system. If the illumination optical system, image formation optical system and auto focus optical system are adjusted in accordance with a specified procedure, it is possible to easily and accurately eliminate measurement error TIS. Since these optical systems are adjusted according to a specified procedure, it is also easy to automate. It is possible to accurately measure overlay position displacement using an optical position displacement measuring device from which a measurement error TIS has been removed.

What is claimed is:

1. An optical position displacement measuring device, comprising:
an illumination optical system that illuminates a measurement mark;
an image formation optical system that converges light reflected from the measurement mark to form an image of the measurement mark;
a image capturing device that captures an image of the measurement mark that has been formed by said image formation optical system;
an image processing device that performs image processing of image signals obtained by said image capturing device to measure positional displacement of the measurement mark; and
a controller capable of positional adjustment of a plurality of optical elements constituting said illumination optical system and said image formation optical system, that carries out positional adjustment of said plurality of optical elements in a predetermined sequence to adjust a measurement error.

2. An optical position displacement measuring device of claim 1, wherein:
said controller performs adjustment of measurement error based on a characteristic curve obtained using a line and space mark made up of a plurality of parallel straight line marks instead of the measurement mark.

3. An optical position displacement measuring device of claim 2, wherein:
said illumination optical system illuminates the line and space mark;
said image capturing device captures an image of the line and space mark formed by converging light reflected from the line and space mark using said image formation optical system;
said image processing device carries out image processing of image signals obtained by said image capturing device to obtain a value representing asymmetry of the line and space mark and to calculate the characteristic curve based on values representing asymmetry of the line and space mark obtained by moving the line and space mark in a direction of an optical axis.

4. An optical position displacement measuring device of claim 1, wherein:
said plurality of optical elements include an illuminating aperture stop comprised in said illumination optical system, and an objective lens and an image forming aperture stop constituting said image formation optical system; and
said controller respectively carries out positional adjustment of said illumination aperture stop, positional adjustment of said objective lens and positional adjustment of said image forming aperture stop.

5. An optical position displacement measuring device of claim 4, wherein:
said controller first carries out positional adjustment of said image forming aperture stop, then carries out positional adjustment of said objective lens, and finally carries out positional adjustment of said illumination aperture stop.

6. An optical position displacement measuring device of claim 4, wherein:
said controller carries out adjustment to flatten out convex shapes of the characteristic curve by positional adjustment of said image forming aperture stop, carries out adjustment to cause variation in inclination of the characteristic curve by positional adjustment of said objective lens, and carries out adjustment to cause parallel shift of the characteristic curve in a direction of a value representing asymmetry of the line and space mark by positional adjustment of said illumination aperture stop.

7. An optical position displacement measuring device of claim 4, further comprising:
an auto focus device that performs auto focus when said image capturing device captures an image formed by said image forming optical system, that is branched from said image formation optical system, and wherein
said controller first carries out auto focus adjustment using said auto focus device, secondly carries out positional adjustment of said image forming aperture stop, thirdly carries out positional adjustment of said objective lens, and finally carries out positional adjustment of said illumination aperture stop.

8. An optical position displacement measuring device of claim 7, wherein:
if a value representing asymmetry of the line and space mark is not within a specified range after finally carrying out positional adjustment of said illumination aperture stop, said controller sequentially and repeatedly carries out auto focus adjustment, positional adjustment of said image formation aperture stop, positional adjustment of said objective lens and positional adjustment of said illumination aperture stop, until the value representing asymmetry of the line and space mark is within a specified range.

9. An optical position displacement measuring device of claim 7, wherein:
said controller carries out auto focus adjustment again using said auto focus device after finally carrying out positional adjustment of said illumination aperture stop.

10. An optical position displacement measuring device of claim 7, wherein:
said auto focus device has a plane parallel glass plate, and auto focus adjustment is carried out after adjustment of said plane parallel glass plate.

11. An adjustment method of an optical position displacement measuring device having an illumination optical system that illuminates a measurement mark, an image formation optical system that forms an image of the measurement mark by converging light reflected from the measurement mark, a image capturing device that captures the image of the measurement mark formed by the image formation optical system, and an image processing device that subjects image signals obtained by the image capturing device to image processing to measure positional displacement of the measurement mark, for carrying out measurement error adjustment by performing positional adjustments of a plurality of optical elements comprised in the illumination optical system and the image formation optical system in a predetermined order.

12. An adjustment method for an optical position displacement measuring device of claim 11, wherein:
adjustment of measurement error is carried out based on a characteristic curve obtained using a line and space mark made up of a plurality of parallel straight line marks instead of the measurement mark.

13. An adjustmennt method for an optical position displacement measuring device of claim 12, wherein:
the line and space mark is illuminated using the illumination optical system;
an image of the line and space mark formed by converging light reflected from the line and space mark using the image formation optical system is captured using the image capturing device;
image signals obtained by the image capturing device are subjected to image processing by the image processing device to obtain a value representing asymmetry of the line space mark and to calculate the characteristic curve based on values representing asymmetry of the line and space mark obtained by moving the line and space mark in the direction of the optical axis.

14. An adjustment method for an optical position displacement measuring device of claim 11, wherein:
the plurality of optical elements include an illuminating aperture stop comprised in the illumination optical system, and an objective lens and an image forming aperture stop comprised in the image formation optical system; and
first positional adjustment of the image forming aperture stop is carried out, then positional adjustment of the objective lens is carried out, and finally positional adjustment of the illumination aperture stop is carried out.

15. An adjustment method for an optical position displacement measuring device of claim 12, wherein:
the optical position displacement measuring device further comprises an auto focus device for performing auto focus when the image capturing device captures an image formed by the image forming optical system, that is branched from the image formation optical system, and
firstly auto focus adjustment is carried out using the auto focus device, secondly positional adjustment of the image forming aperture stop is carries out, thirdly positional adjustment of the objective lens is carried out, and finally positional adjustment of the illumination aperture stop is carried out.
